(19) United States
(12) Patent Application Publication
(10) Pub. No.: US 2009/0077609 A1
(43) Pub. Date: Mar. 19, 2009

(54) Gateway For Receiving Digital Television Broadcast Services, Terminal and Corresponding Methods

(76) Inventors: Guillaume Bichot, La Chapelle Chaussee (FR); Helmut Burklin, Rennes (FR); Ali Boudani, Rennes (FR)

Correspondence Address: Robert D. Shedd;Thomson Licensing LLC, PO Box 5312, PRINCETON, NJ, 08543-5312, US

(21) Appl. No.: 12/087,839

(22) PCT Filed: Jan. 17, 2007
(86) PCT No.: PCT/EP2007/050437

§ 371 Date: Nov. 17, 2008

(30) Foreign Application Priority Data
Jan. 17, 2006 (FR) 0650164
Mar. 30, 2006 (FR) 0651124

(51) Int. Cl. H04N 7/173

(52) U.S. Cl. 725/127

(57) ABSTRACT

The invention concerns a gateway comprising means for receiving the first frames of a digital video broadcasting service, characterized in that it comprises:
means for determining data representative of a time-slice,
means for encapsulating each of the first service frames in a second frame comprising said data representative of a time-slice, and
means for transmitting over a wireless local area network each second frame to a digital audio/video terminal.

### 1. SCOPE OF THE INVENTION

This invention relates to the Digital Video Broadcast field (or DVB). More precisely, the invention concerns the broadcasting and reception of DVB-H (DVB-Handheld) services associated with hand-held terminals.

### 2. TECHNOLOGICAL BACKGROUND

The DVB is in particular defined in the ETSI EN 301 192 standards (entitled ‘Digital Video Broadcasting (DVB); DVB specification for data broadcasting’ and TR 101 190 (entitled ‘Digital Video Broadcasting (DVB); Implementation guidelines for DVB terrestrial services; Transmission aspects’). The DVB-H is in particular specified in the ETSI EN 302 304 standards (entitled ‘Digital Video Broadcasting (DVB); Transmission System for Handheld Terminals (DVB-H)’ and TR 102 377 (entitled ‘Digital Video Broadcasting (DVB); DVB-H Implementation Guidelines’).

According to the prior art, a DVB-H television service (for example of the live television type or of the ‘Video On Demand’ (VOD) type can be downloaded. FIG. 1 diagrammatically illustrates a DVB-H network infrastructure used for the transmission of a DVB-H video service to a terminal 10 according to the H264 standard in QCIF (Quarter of ‘Common Intermediate Format’ corresponding to a 176×144 resolution). The infrastructure comprises in particular:
an IP network backbone 13,
a video coder 14 receiving data from a receiver 140 and codes (or transcodes) life channels,
servers, respectively of VOD 150, EPG 151, and a portal 152,
a cellular network 12,
a DVB-H network 11, and
the terminal 10.

The servers 14 and 150 to 152 transmit DVB-H services to the terminal 10 via the IP 13 network and the DVB-H network 11. The average rate of the entire service is equal to about 250 kbits/s. The service gathers several IP (Internet Protocol) streams: one for video, one for audio and, possibly, other services (for example, session description (according to an SDP protocol).

The DVB-H network 11 comprises in particular:
a module 110 for IPE (IP Encapsulation) of the DVB-H type,
a DVB-H 111 backbone, and
a transmitter 112.

The DVB-H IPE module 110 receives multicast streams 160 from the IP 13 network according to a protocol of the RTP (‘Real Time Protocol’) type on UDP/IP (‘User Datagram Protocol on IP’). According to their configuration, the module 110 transmits them to the backbone 111 by grouping the streams belonging to the same service in the form of MPEG-TS (‘Motion Picture Expert Group—Transport Stream’) streams and encapsulates them in a frame 161 with time slicing by adding to them forward error correction (FEC) information and signalling information according to the DVB-H standard. The transmission rate is generally high and can reach, for example, 10 Mbits/s. The MPEG-TS stream 161 is transmitted to the transmitter 112 via the backbone 111. The transmitter 112 then transmits along a DVB-H radio channel the MPEG-TS stream to the terminal 10. The terminal 10 then analyzes the DVB-H signalling information present in the stream 16, associates an IP address with a MPEG-TS address and can then read all IP packets associated with this address and reconstructs the various streams 160 transmitted originally.

The cellular network 12 is of the 3G (that is to say third generation) type and comprises in particular:
a gateway 120 of cellular network GGSN,
a backbone 121, and
a transmitter 122 (for example, a base station).

The terminal 10 can exchange control data with the transmitter 122 allowing an interactivity with the service provider, video type data transiting via the DVB-H transmitter 112.

Such an infrastructure has the drawback of not being accessible when the terminal cannot correctly receive the signals transmitted by the transmitters 112 and 122.

### 3. SUMMARY OF THE INVENTION

The purpose of the invention is to overcome the disadvantages of the prior art.

More particularly, the purpose of the invention is to make it possible to receive digital television services when the reception of DVB-H signals via a DVB-H radio transmitter is not possible or difficult, in particular inside buildings, while allowing power saving of the terminal.

For this purpose, the invention proposes a gateway comprising means for receiving the first frames of a digital video broadcasting service via, for example, a wired network, characterized in that it comprises:
means for determining data representative of a time-slice,
means for encapsulating each of the first service frames in a second frame comprising said data representative of a time-slice, and
means for transmitting over a wireless local area network each second frame to a digital audio/video terminal.

According to a particular characteristic, said gateway comprises means for inserting data representative of a time-slice in each second frame according to a session description protocol.

According to a particular characteristic, said session description protocol is of the SAP-SDP type.

According to particular characteristics, the means for receiving the first frames of a digital video broadcasting service are associated with a wired network or a wireless network.

According to a particular characteristic, said wired network is a broadband network used in particular to transmit a video stream.

According to a particular characteristic, said wireless network is of the IEEE 802.11, Hiperlan, IEEE802.15 or IEEE802.16 type in a configuration of the private or public local area network type (for example of the ‘hot-spot’ type).

According to a particular characteristic, said gateway comprises means for detecting a power saving mode of a terminal receiving said second frames in such a way as to transmit each second frame when the destination terminal is in the listening mode.

According to a particular characteristic, said service is of the DVB-H type.

According to a particular characteristic, each second frame comprises a destination address corresponding to only one terminal.

According to a particular characteristic, each second frame comprises a destination address corresponding to several terminals.

The invention also concerns a terminal which comprises:
means for receiving second frames comprising data representative of a time-slice, the second frames being transmitted over a wireless local area network, and
means for extracting first service frames from said second frames.

The invention also relates to a method for broadcasting digital video services comprising a step for receiving the first frames of a digital video broadcasting service via, for example, a wired network, characterized in that it comprises:
a step for determining data representative of a time-slice,
a step for encapsulating each of the first service frames in a second frame comprising said data representative of a time-slice, and
a step for transmitting over a wireless local area network each second frame to a digital audio/video terminal.

The invention also relates to a digital audio/video receiving method, characterized in that it comprises:
a step for receiving second frames comprising data representative of a time-slice, the second frames being transmitted over a wireless local area network, and
a step for extracting first service frames from said second frames.

### 4. LIST OF FIGURES

The invention will be better understood, and other specific features and advantages will emerge from reading the following description, the description making reference to the annexed drawings wherein:

FIG. 1 diagrammatically illustrates an infrastructure, known in itself, of DVB-H network allowing the transmission of a DVB-H video service to a terminal,

FIG. 2 is a diagrammatical block diagram of a network infrastructure implementing a particular invention embodiment,

FIG. 3 presents a network infrastructure according to an invention embodiment variant,

FIGS. 4 and 5 illustrate the structure of a frame transmitted by access point of the network of FIG. 2,

FIG. 6 presents the exchanges between elements of the network of FIG. 2,

FIGS. 7 and 8 illustrate the structure respectively of a terminal and of an access point of the network of FIG. 2,

FIGS. 9 and 10 describe algorithms implemented in the elements of FIGS. 7 and 8,

FIG. 11 describes an algorithm implemented in a terminal of the network of FIG. 3,

FIG. 12 is a diagrammatical block diagram of a network infrastructure implementing an invention embodiment variant, and

FIG. 13 presents the exchanges between elements of the network of FIG. 12.

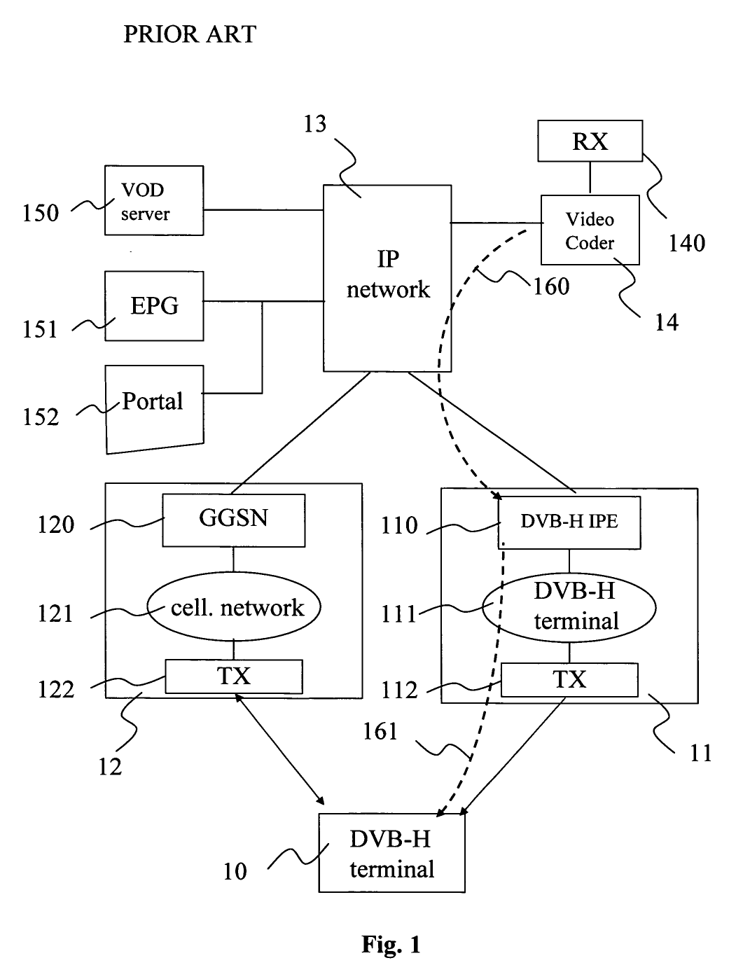

### 5. DETAILED DESCRIPTION OF THE INVENTION

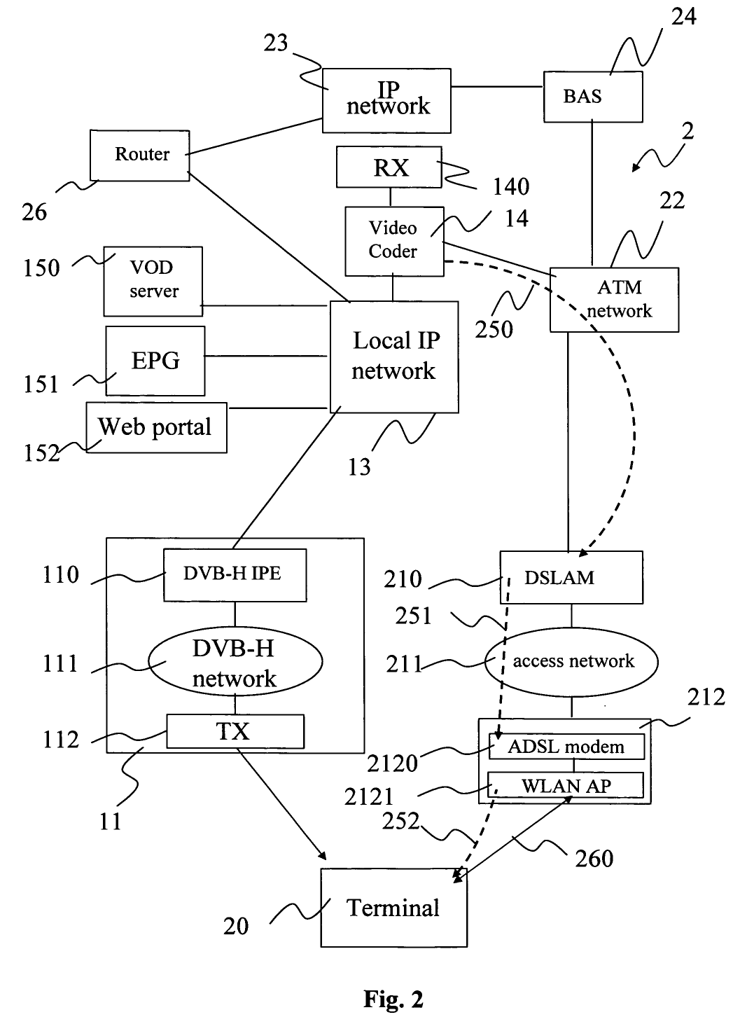

FIG. 2 presents a diagrammatic block diagram of a network infrastructure 2 implementing a particular invention embodiment with an infrastructure combining DVB-H, x SDSL (or ‘x-Digital Subscriber Line’) and WLAN (‘Wireless Local Area Network’) elements.

The network infrastructure 2 comprises in particular:
a IP network backbone 13 specific to the service provider which interconnects the elements of the service provider,
an IP network backbone 23 which is used to connect an ADSL network to the IP network 13,
a video coder 14 receiving data from a receiver 140,
servers respectively of VOD 150, EPG (or ‘Electronic Program Guide’) 151 or ESG (or ‘Electronic Service Guide’ according to the DVB-H terminology), and a ‘web portal’ (which is a http/html or wap server enabling an interaction with the DVB-H service provider) 152,
a DVB-H network 11
an IP router 26 used to interconnect the IP networks 13 and 23,
a broadband network (for example of the ATM type) 22,
a BAS (‘Broadband access server’) element which belongs to the ADSL structure and interconnects the broadband network 22 and the IP network 23,
a DSLAM module 210,
an access network 211,
an ADSL modem 2120,
a WLAN access point 2121 (grouped in a gateway 212 with the modem 2120), and
a terminal 20 preferentially mobile and for example of the PDA or mobile phone type.

The network 2 comprises elements 13, 150 to 152 similar to the elements of the infrastructure 1 that have the same references.

The portal 152 and the servers 150 and 151 are connected to the network 13.

The servers 14 and 150 to 152 transmit DVB-H services to the terminal 20 via the IP 13 network and the DVB-H 11 network when the terminal is in an area covered by the transmitter 112 and more generally the network 11.

When the terminal 20 cannot correctly receive the signals transmitted by the transmitter 112 (and/or possibly via a cellular network not represented) the terminal 20 receives a DVB stream 252 via a local area network connected to the network 22. According to various invention variants, the terminal 20 connects to the wireless local area network upon detection of an incorrect reception of the DVB-H stream via the DVB-H (and or cellular) network, upon detection of the presence of a local area network (the local area network can be given priority by parameterization or user's request), upon user's request.

The ATM network 22 is connected to the video coder 14 and receives a video stream from the coder 14 that it retransmits to the DSLAM module 210. The DSLAM module 210 duplicates and sends IP packets relating to the selected streams to the modem 2120 via the network 211. The WLAN access point 2121 receives the data concerning the selected streams from the modem 2120, formats it by encapsulating it in a burst 252 to broadcast it over a wireless local area network where the terminal 20 is which can thus receive the burst 252 intended to it.

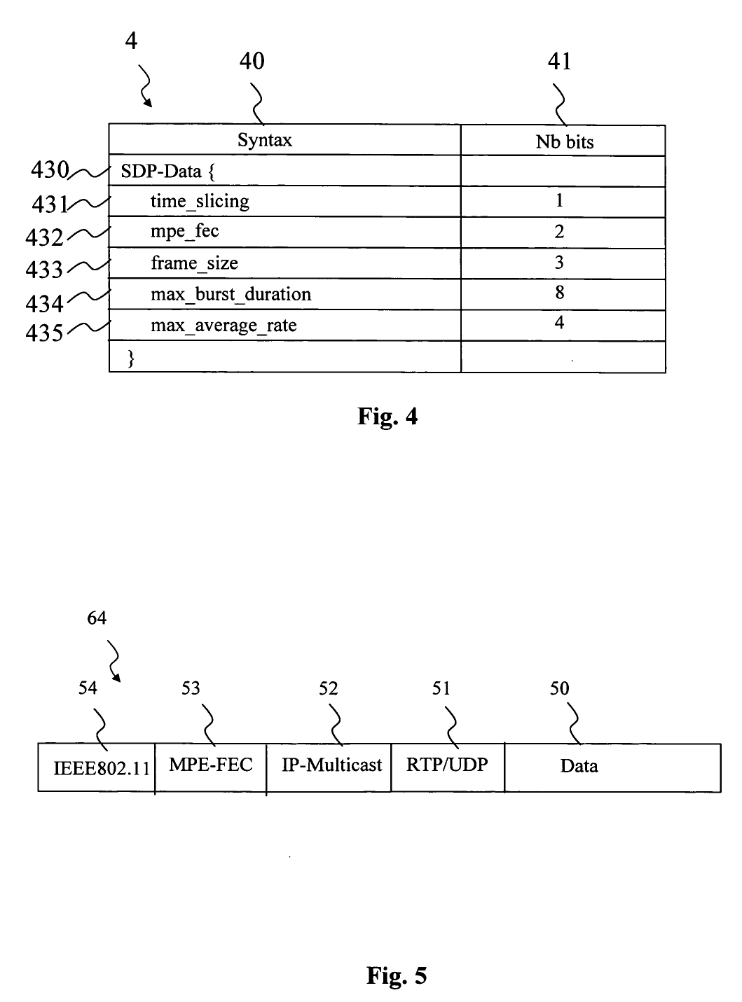

FIG. 4 represents the control data 430 (per service) transmitted according to an IP broadcasting protocol (SAP-SDP or Session Announcement Protocol-Session Description Protocol) by the access point 2121 to the terminal 20. They are preferentially transmitted regularly and are not likely to change frequently. The data 430 comprises the following elements (which are specified in the DVB-H standard):
indication 431 of time slicing use on one bit,
indication 432 of error correction on 2 bits,
size 433 of the MPE frame on 3 bits,
maximum time 434 of a burst (information quantity transmitted in a time slice), and
maximum average rate 435 of the service.

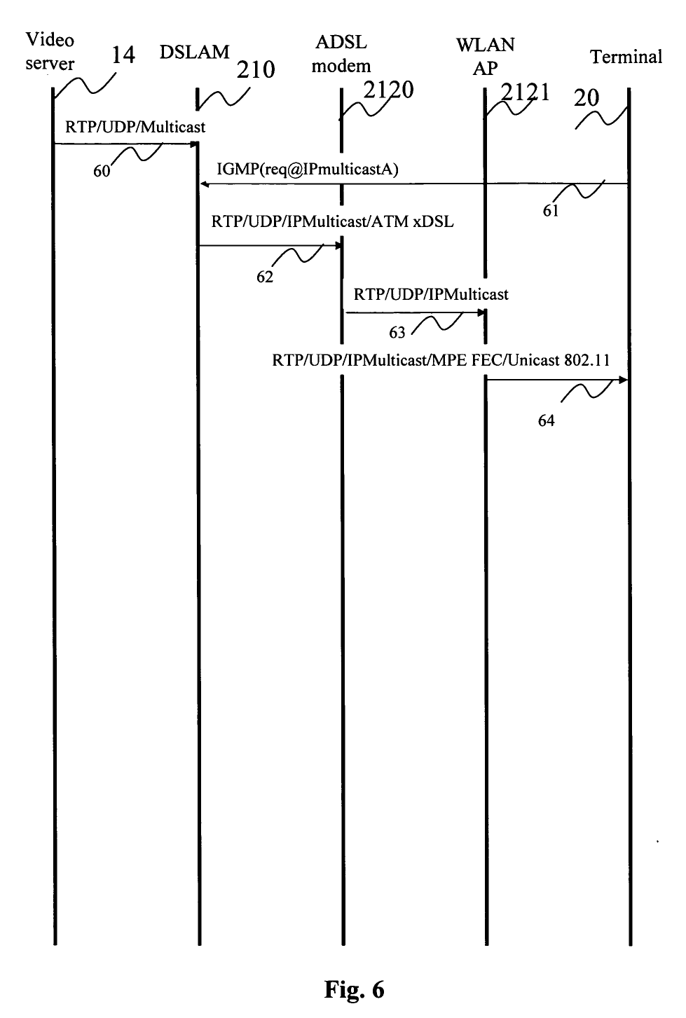

FIG. 6 presents the exchanges between the video coder 14, the DSLAM module 210, the ADSL modem 2120, the access point 2121 and the terminal 20.

The video coder 14 transmits to the DSLAM module 210, frames 60 (or 250 on FIG. 2) containing a video stream according to a multicast protocol of the RTP/UDP type. This transmission is systematic or, preferentially, initiated when at least a DSLAM requires a digital audio/video service. When the terminal 20 cannot correctly receive the data via the DVB-H network 11, it transmits a request 61 to the DSLAM module 210. The request 61 is of the IGMP (or ‘Internet Group Management Protocol’) type and comprises the IP address of the desired video stream to select the corresponding service. The address of the desired video stream can be determined via a http point-to-point connection beforehand to the web portal 152 or thanks to a stream coming from the EPG server 151 (which corresponds to a stream with a known address of the terminal 20).

Following the reception of the request 61, the DSLAM module 210 duplicates the video stream contained in the frames corresponding to the IP address of the desired stream and transmits it to the modem 2129 in the form of a xDSL stack 62, for example of the ATM/AAL5/ADSL type.

Then, the ADSL modem 2120 extracts the video stream from the stack 62 and encapsulates it in a frame 63 of the IP broadcast type (multicast IP frame of the RTP/UDP type) that it transmits to the WLAN access point 2121.

Then, the access point 2121 carries out an encapsulation in a wireless frame 64 as illustrated in respect of FIG. 5. The access point 2121 codes the frame to protect the frame against transmission errors between the access point 3021 and the terminal 20 (the terminal 20 implementing the corresponding decoder to correct possible transmission errors). The access point 2121 also implements a time slicing compatible with the wireless transmission protocol between the access point and the terminal 20. This protocol is for example of the IEEE802.11 type or Hiperlan type II. The modem 2120 and the access point 2121 are implemented in two separate physical units (for example component or electronic board). According to an embodiment variant, the modem 2121 and the access point 2120 are implemented in a single physical unit, for example in the form of an ADSL residential gateway. The invention indeed makes it possible to keep the power conservation possibilities offered by DVB-H for the terminals. The reduction of power consumption, according to the invention, is carried out by means of time slicing when the packets are transmitted by the access point 2120 over a wireless local area network. An increased reliability is also obtained by adding forward error correction (or FEC) data in the bursts.

The frame 64 comprises:
control data 54 specific to wireless transmission (for example, data used to equalise the radio signal and data describing the frame 64 (for example, length, source address and destination address )),
data 53 for forward error correction (FEC) and time slicing,
a IP 52 multicast address corresponding to the service requested by the terminal 20 for the selected service,
data 51 specific to the RTP/UDP protocol, and
video stream data 50 corresponding to the video stream required by the terminal 20.

In the MAC (or ‘Medium Access Control’) layer, an address corresponding to the destination terminal alone (‘unicast’ and not multicast) is used. If there are several terminals, the packet is duplicated and transmitted on the wireless network to each terminal in the MAC unicast mode.

According to an invention embodiment variant, (when in particular the transmission between the access point 2121 and the terminal 20 is supposedly of good quality), no forward error correction data is inserted in the frame 64. In the point-to-point link mode, a mechanism for acknowledgement (and possibly retransmission of frames not acknowledged within a predetermined time) is advantageously implemented whether there is forward error correction data or not, which makes it possible to secure the link and therefore improve the quality of service.

The MPEG-TS format is not required for transporting video in a WLAN unlike DVB-H.

Preferentially, the format of the data 53 corresponds to the format defined by the DVB-H standard in order to simplify the implementation of the terminal 20 which comprises means for receiving a DVB-H stream. According to an embodiment variant, the data 53 do not correspond to the format defined by the DVB-H standard. In particular, the FEC data can be specified according to the characteristics of the transmission channel on the wireless local area network.

Preferentially, according to the invention, the data transmission on the local area network implements FEC and time slicing data according to the same format as that implemented within the framework of the MPEG DVB-SI standard applied to DVB-H, for information of the same nature. According to the invention, advantageously, the session description format is compatible with the SDP protocol, a SDP stream transporting the session parameters useful for the coders/decoders, the time slicing of the DVB-H type and a FEC description. In order to implement time slicing and FEC compatible with that of the DVB-H standard, the data 53 for forward error correction FEC and time slicing coded in a SDP frame is formatted according to the table of FIG. 5 (columns 40 to 42 of which represent respectively the significance of each field, its size in bit number and an identifier) comprises:
a flag which indicates if the time slicing 433 is implemented on 1 bit,
a FEC field 434 indicates if a correction mechanism is implemented on 2 bits,
a size of the MPE frame on 3 bits,
a maximum time of a burst (which corresponds to a set of element packets transmitted sequentially) (thanks to the indicated maximum burst time, if the terminal does not receive the burst end signal after this maximum time, it knows that the link is cut off and can try to switch to the DVB-H network if the cut corresponds to the out of reach placement of the WLAN network or wait for a user's request, if the break corresponds to an end of stream transmission on the ADSL network) on 8 bits,
a maximum average rate on 4 bits,
a time slicing and FEC identification on 4 bits, and
and N bytes 440 for identifier selection on 8N bits.

The wireless network is preferentially compatible with an IEEE 802.11x standard (x corresponding to a version of the standard and is, for example a, b, g, etc.). These standards define a power saving (or PS) mode. During a first or new association, the terminal 20 indicates to the access point 3021 the listening period or interval, that is to say the time elapsed between two listening operations. This time is expressed in number of periods of control frames called ‘beacons’. A beacon control frame is a management frame transmitted periodically by the access point 3021. The corresponding period is a configuration parameter of the access point 3021. It is a multiple of 10 ms which corresponds to the minimum value of Δt such as specified in the DVB-H standard (10 ms<Δt<40 s). Hence, the listening interval is calculated by the terminal 20 and corresponds to the DVB-H Δt parameter indicated in the header of the data 53 of a received frame.

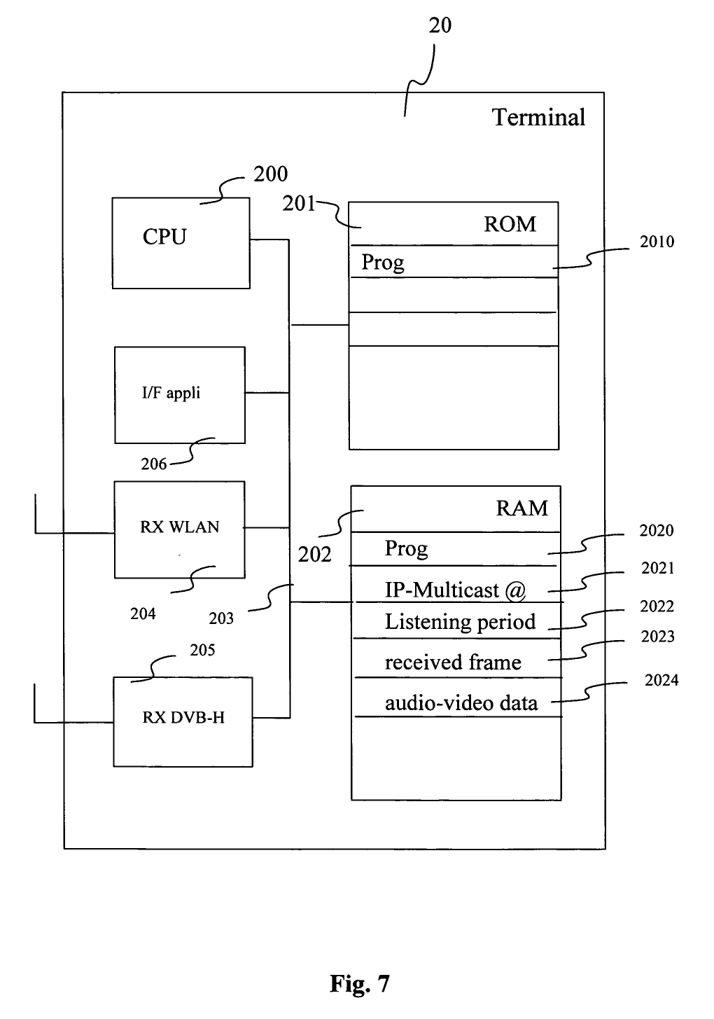

FIG. 7 diagrammatically illustrates the terminal 20.

The terminal 20 comprises, interconnected by address and data bus 203:
a microprocessor 200 (or CPU),
a non-volatile memory of the ROM type (Read Only Memory) 201,
a Random Access Memory or RAM 202,
a module 204 for receiving the signal received on the WLAN wireless network,
a module 205 for receiving the signal received on the DVB-H (or 3G) network, and
an interface 206 transmitting the received images to the audio/video application (for example, for display or record).

Moreover, each of the elements illustrated in FIG. 7 is well known by the person skilled in the art. These common elements are not described here.

It is noted that the word “register” used in the description designates in each of the memories mentioned, a memory zone of low capacity (some binary data) as well as a memory zone of large capacity (enabling a whole programme to be stored or all or part of the data representing an audio/video service received).

The memory ROM 201 comprises in particular:
a program ‘prog’ 2010.

The algorithms implementing the steps of the method described hereafter are stored in the memory ROM 205 associated with the terminal 20 implementing these steps. When powered up, the microprocessor 20 loads and runs the instructions of these algorithms.

The random access memory 202 comprises in particular:
in a register 2020, the operating programme of the microprocessor 200 responsible for switching on the terminal 20,
an IP address for multicast corresponding to a service required in a register 2021,
a listening interval value (or ‘beacon’) in a register 2022,
one or more audio/video frames received in a register 2023, and
audio/video data corresponding to the requested service in a register 2024.

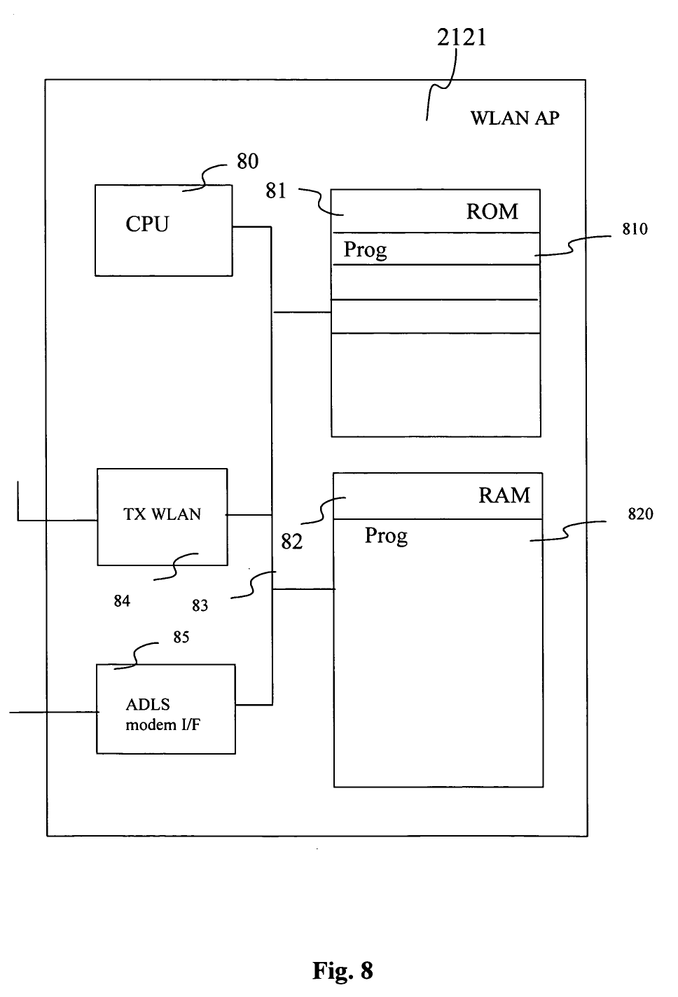

FIG. 8 diagrammatically illustrates the access point 2121.

The access point 2121 comprises, interconnected by address and data bus 83:
a microprocessor 80 (or CPU),
a non-volatile memory of the ROM (Read Only Memory) type 81,
a random access memory or RAM 82,
a module 84 for transmitting the signal received on the WLAN wireless network, and
a module 85 for receiving the signal on the wired network.

Moreover, each of the elements illustrated in FIG. 8 is well known by the person skilled in the art. These common elements are not described here.

It is noted that the word “register” used in the description designates in each of the memories mentioned, a memory zone of low capacity (some binary data) as well as a memory zone of large capacity (enabling a whole programme to be stored or all or part of the data representing an audio/video service received).

The memory ROM 81 comprises in particular:
a program ‘prog’ 810,

The algorithms implementing the steps of the method described hereafter are stored in the ROM memory 810 associated with the access point 2121 implementing these steps. When powered up, the microprocessor 80 loads and runs the instructions of these algorithms.

The random access memory 82 comprises in particular:
in a register 820, the operating programme of the microprocessor 80 responsible for switching on the access point.
an IP address for multicast corresponding to a service required in a register 821,
a listening interval value (or ‘beacon’) in a register 822,
one or more audio/video frames received in a register 823, and
audio/video data corresponding to the requested service in a register 824.

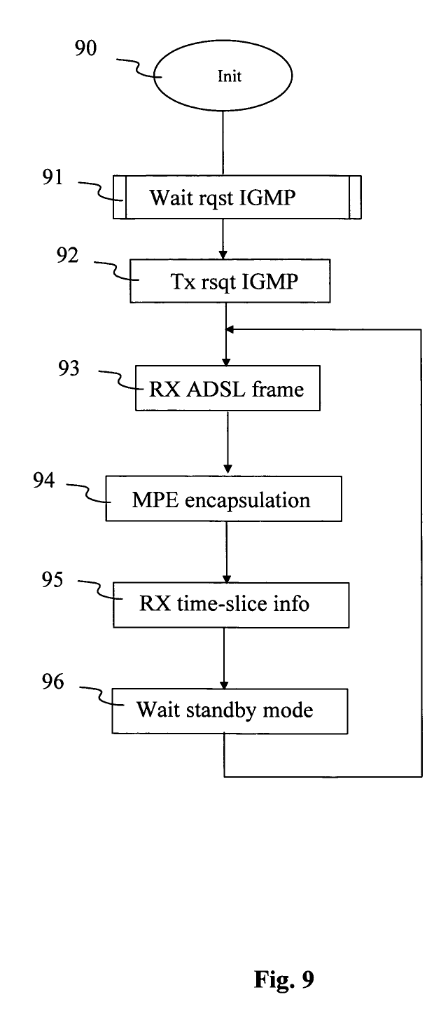

FIG. 9 illustrates a receiving algorithm implemented in the access point 2121.

During a first step 90, the access point 2121 initializes the various transmission and reception parameters.

Then, during a step 91, it receives an IGMP request from the terminal 20, that it retransmits to the modem 2120, during a step 92.

Then, during a step 93, the access point 2121 receives IP multicast frames from the modem 2120 corresponding to ADSL frames received from DSLAM. Then, during a step 94, it carries out an encapsulation of the MPE type in a wireless frame 64 such as illustrated in respect of FIG. 5.

During the step 95, the configuration information of the time slicing and possible FEC encoding is recovered. The MPE-FEC header then contains the real time parameters useful for the terminal 20 to carry out the reverse time slicing and the FEC decoding if necessary.

Then, during a step 96, the access point 2121 receives from the terminal 20 a control frame of the PS-POLL type with a bit indicating that the terminal 20 exits the power saving mode. The access point 2121 then transmits to the terminal 20, the frames 64 of the MPE type stored in its corresponding buffer memories.

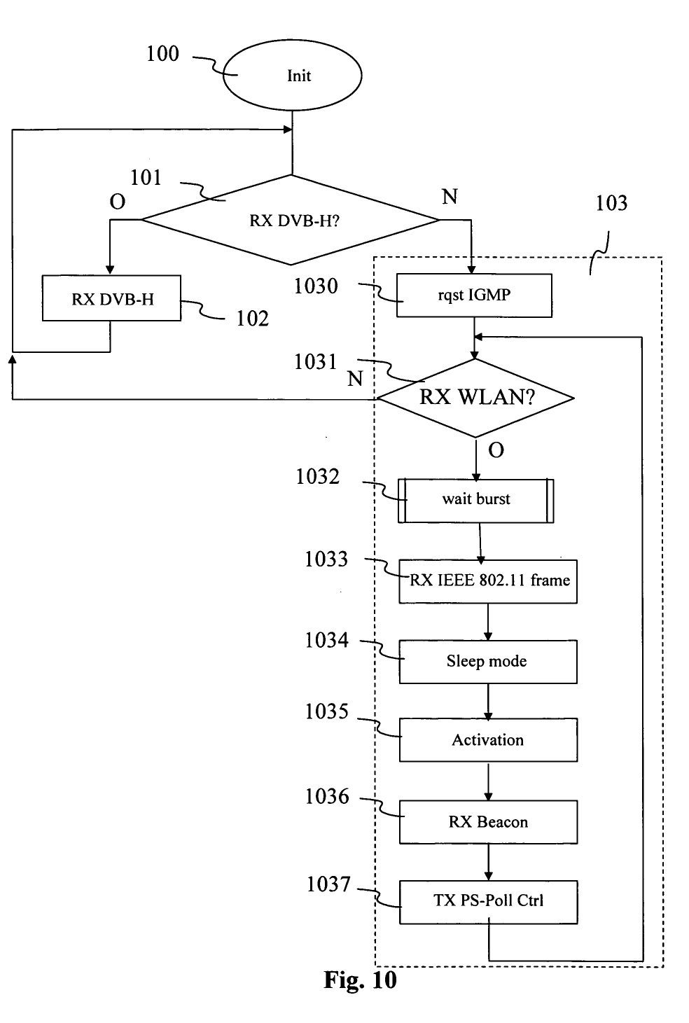

FIG. 10 illustrates a receiving algorithm implemented in the terminal 20.

During a first step 100, the terminal 20 initializes the various reception parameters. Then, during a step 101, it checks if it correctly receives a DVB-H stream from the DVB-H network. If this is the case, supposing that the DVB-H network has priority with respect to the WLAN network (by parameterization, construction or indication of the user), during a step 102, the terminal 20 receives a DVB-H stream from the DVB-H network. When the terminal 20 no longer receives a DVB-H stream, the step 101 is repeated.

In the negative, the terminal 20 does not receive or incorrectly receives (that is to say with many errors) a DVB-H stream or the user requested a handover to the WLAN network, during a step 103, the terminal receives an audio-video stream from the WLAN network after request.

The step 103 starts with a step 1030, during which the terminal 20 emits to the WLAN access point 2121 a DVB-H stream request in the form of an IGMP request (request 61). The IP multicast address can be determined beforehand (for example during the initialization phase or reception beforehand via the DVB-H network (thanks to a EPG list) or ADSL (via http or thanks to a EPG list)). In addition, during the step 1030, the terminal receives general information (corresponding to the data 430 illustrated in FIG. 4) on time slicing and MPE-FEC such as configured by the access point.

Then, during a test 1031, the terminal 20 checks if it can receive WLAN bursts (this step can be carried out at any time (and in particular before the step 1030)).

In the negative (the WLAN signal is not received or is received with too many errors, or the user required a handover to the DVB-H network), the step 103 ends and the step 101 is repeated.

In the affirmative (the WLAN signal can be correctly received), during a step 1032, the terminal 20 waits and receives an entire DVB-H burst which corresponds to several frames received via the WLAN network with a destination address specific (or ‘unicast’) to the terminal 20.

Then, during a step 1033, the terminal 20 processes the data contained in the IEEE802.11 frames received and corresponding to a burst. During this step, the possible transmission errors are corrected using FEC data. Having received a first burst, the terminal 20 can implement the WLAN power saving mode according to the MPE parameters contained in the burst.

Then, during a step 1034, based on the Δt information contained in the MPE header (the other MPE part comprising information relating to the IP frame) the terminal transmits to the access point 2121 a signalling frame mentioning the listening interval and indicates to it that it enters a power saving mode. The terminal 2121 then goes into sleep mode.

Then, during a step 1035 (after expiry of a timeout corresponding to the listening interval), the terminal 20 wakes up (listening mode) and, during a step 1036, it waits for a ‘beacon’ frame which comprises a TIM (or ‘traffic indication map’) which indicates the number of incoming frames memorized in the access point 2121, intended for the terminal 20.

Then, during a step 1037, the terminal 20 transmits to the access point 2121 a control frame of the PS-POLL type with a bit indicating that the terminal 20 exits the power saving mode so that the access point 2121 can empty the corresponding buffer memories and resume the transmission of the frames to the terminal at the maximum rate.

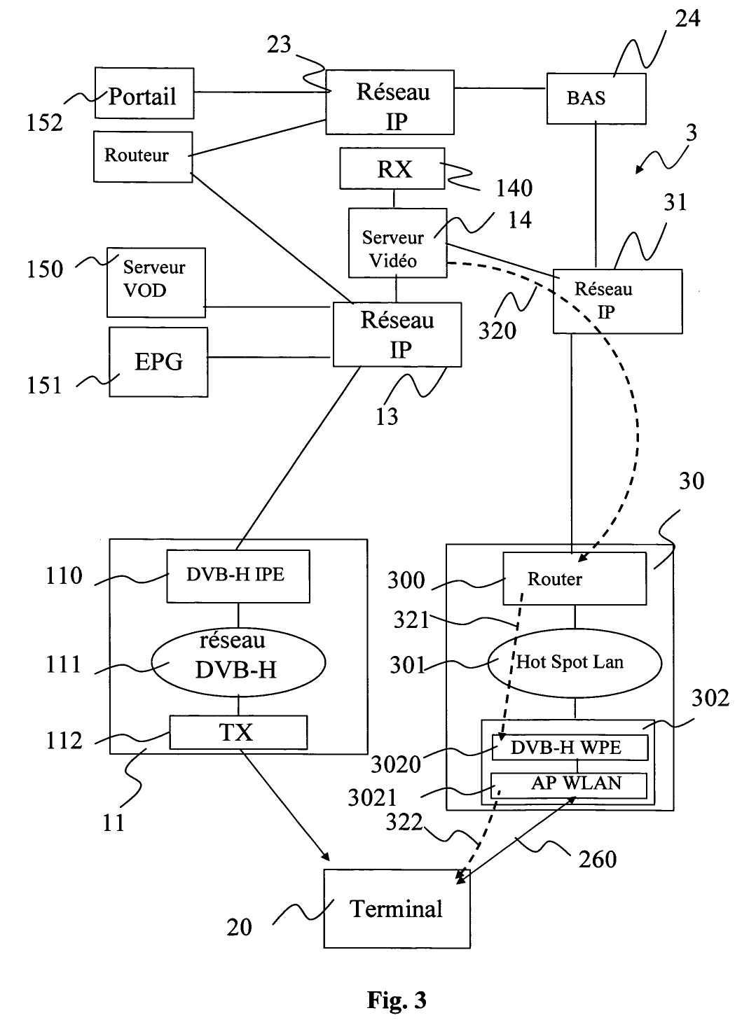

FIG. 3 presents a diagrammatical block diagram of a network infrastructure 3 implementing a variant of the network 2, the ATM network intended for a gateway for residential use being replaced, more generally, by a IP network used to provide a public access.

The elements common to the networks 2 and 3 have the same references and, unlike otherwise indicated, are connected in the same manner.

The infrastructure of the network 3 comprises in particular:
an IP network backbone 13,
an IP network backbone 23,
a video coder 14 receiving data from a receiver 140,
servers respectively of VOD 150, EPG 151 and a web portal 152,
a DVB-H network 11
an IP router 26 used to interconnect the IP networks 13 and 23,
an IP network 31,
a BAS element which interconnects the IP 31 network and the IP network 23,
a router 300,
an access network 211,
a hot spot LAN 301,
a DVB-H WPE (‘Wireless LAN Protocol encapsulator’) interface 3020,
a WLAN access point 3021 (grouped in a gateway 302 with the interface 3020), and
a terminal 20.

The interface 3020 implements the MPE encapsulation, FEC and time slicing mechanisms in a similar manner as the implementation of the access point 2121. The access point 3021 is thus, preferentially, a standard access point.

When the terminal 20 cannot correctly receive the signals transmitted by the transmitter 112 (and/or possibly via a cellular network not represented) the terminal 20 receives a DVB stream 252 via a local area network connected to the network 31. According to various invention variants, the terminal 20 connects to the wireless local area network upon detection of an incorrect reception of the DVB-T stream via the DVB-T (and or cellular) network, upon detection of the presence of a local area network (the local area network being able to be given priority by parameterization or user's request), upon user's request.

The IP 31 network is connected to the video coder 14 and receives a video stream from the coder 14 that it retransmits to the router 300. The router 300 duplicates and sends IP packets relating to the selected streams to the interface 3020 via the network 301. The WLAN access point 3021 receives the data concerning the selected streams from the interface 3020, formats it by encapsulating it in a burst 322 to broadcast it over a wireless local area network where the terminal 20 is which can thus receive the burst 322 intended for it.

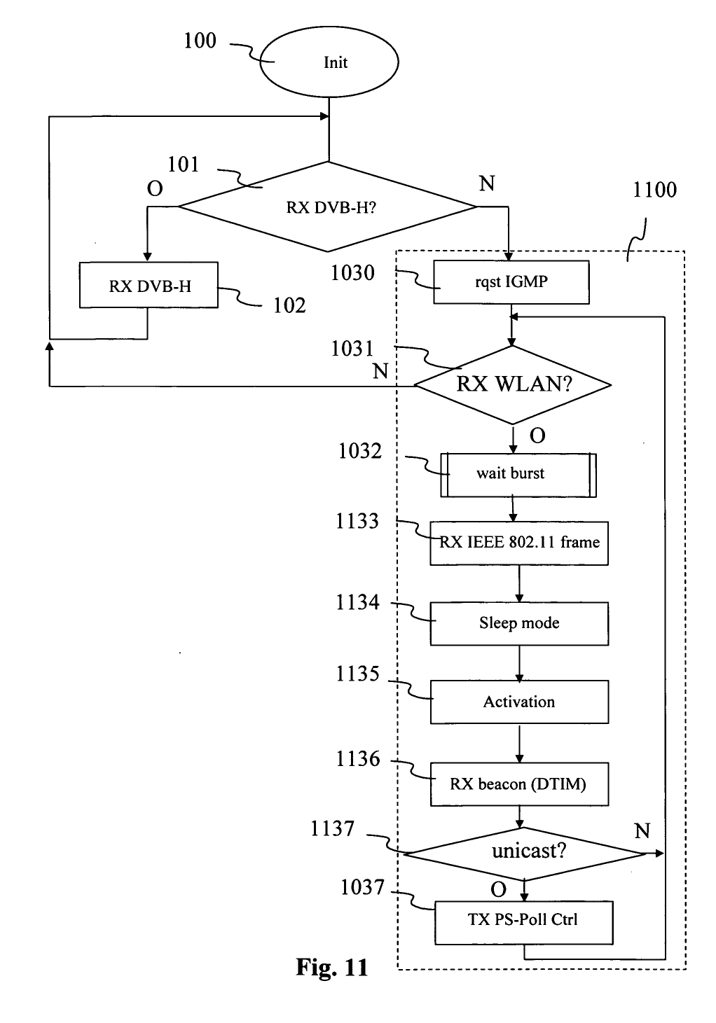

FIG. 11 illustrates a receiving algorithm implemented in the terminal 20 when it is connected to an access point 3021.

The steps 100, 101 and 102 are similar to those described in respect of FIG. 10 and which have the same references.

In particular, during the step 100, in the MAC multicast mode, the access point 3021 will be configured with a DTIM (‘Delivery Traffic Indication Message’) period initialized to 1 (which corresponds to the number of ‘beacon’ periods during which the access point 3021 memorizes the frames).

A step 1100 replaces the step 103. It implements the steps 1030, 1031, 1032 similar to those of FIG. 10 and which have the same references, the frames being transmitted to or received from the access point 3021.

In the affirmative (the WLAN signal can be correctly received), during a step 1032, the terminal 30 waits and receives an entire DVB-H burst which corresponds to several frames received via the WLAN network with a MAC multicast destination address.

Then, during a step 1133, the terminal 20 processes the data contained in the IEEE802.11 frames received and corresponding to a burst. The frames received are, moreover, in multicast mode as soon as several terminals are connected to the access point (and not with a single reception address corresponding to that of the terminal 20). The operations carried out during the step 1133 are moreover similar to those carried out by the step 1033.

Then, during a step 1134, based on the Δt information contained in the MPE header (the other MPE part comprising information relating to the IP frame) the terminal transmits to the access point 3021 a signalling frame mentioning the listening interval and indicates to it that it enters a power saving mode. The terminal 20 then goes into sleep mode. It is up to the access point to memorize the packet frames during a Δt time and to send the frames at the maximum rate.

Then, during a step 1135 (after expiry of a timeout corresponding to the listening interval), the terminal 20 activates (listening mode) and, during a step 1136, it waits for a ‘beacon’ frame which comprises a DTIM which indicates the number of multicast frames memorized in the access point 3021, intended for the terminal 20.

Then, during a test 1137, the terminal 20 checks if it has also received a unicast packet intended for itself.

In the negative, the test 1031 is repeated.

In the positive, during a step 1037, the terminal 20 transmits to the access point 2121 a control frame of the PS-POLL type with a bit indicating that the terminal 20 exits the power saving mode so that the access point 3021 can empty the corresponding buffer memories and resume the transmission of the frames to the terminal at the maximum rate.

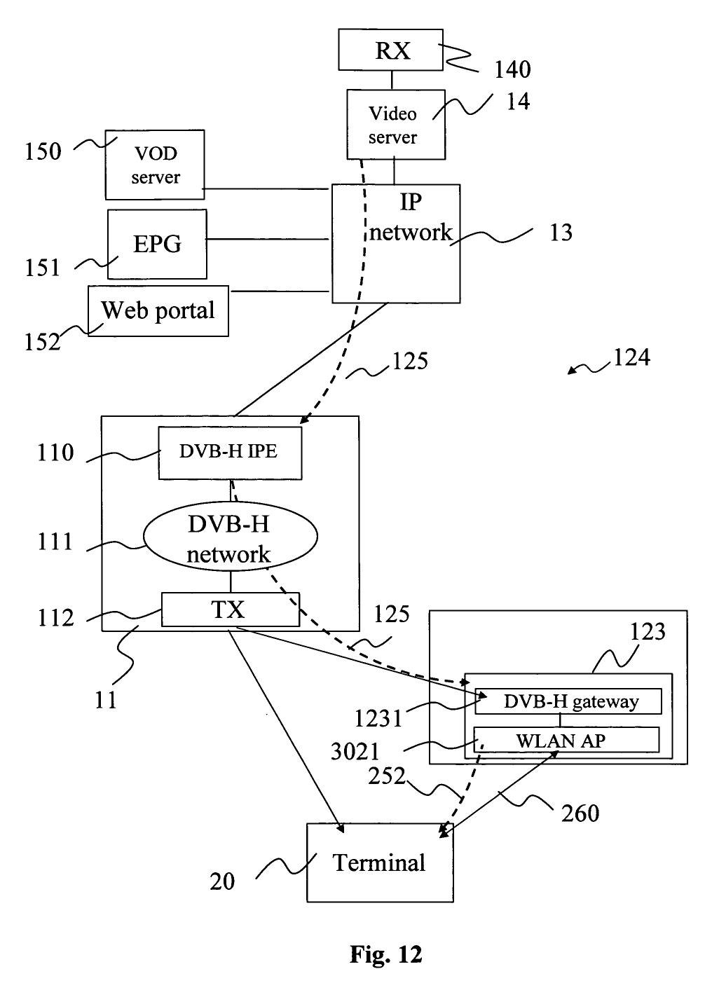

FIG. 12 presents a diagrammatic block diagram of a network infrastructure 124 implementing a particular invention embodiment with an infrastructure based on a DVB-H network 11 and a wireless local area network (or WLAN ).

The network infrastructure 124 comprises in particular:
a IP 13 network backbone,
a video coder 14 receiving data from a receiver 140,
servers respectively of VOD 150, EPG 151 and a web portal 152,
the DVB-H network 11
an IP 26 router used to interconnect the IP 13 and 23 networks,
a DVB-H gateway 1231,
a WLAN access point 3021 (grouped in a gateway 123 with the gateway 1231), and
a terminal 20 preferentially mobile and for example of the PDA or mobile phone type.

The network 124 comprises elements 13, 23, 14, 140, 150 to 152, 11, 26 and 20 similar to the elements of the network 2 which have the same references and will not be described in more detail.

When the terminal 20 cannot correctly receive the signals transmitted by the transmitter 112 (and/or possibly via a cellular network not represented) the terminal 20 receives a DVB stream 252 via a local area network connected to the network 11. According to various invention variants, the terminal 20 connects to the wireless local area network upon detection of an incorrect reception of the DVB-T stream via the DVB-T (and or cellular) network, upon detection of the presence of a local area network (the local area network being able to be given priority by parameterization or user's request), upon user's request.

The DVB-H network 11 is connected to the video coder 14 and receives a video stream 125 from the coder 14 that it retransmits to the gateway 123. The gateway 1231 duplicates and sends IP packets relating to the selected streams to the WLAN access point 3021 similar to the access point 2120 described above. The WLAN access point 2120 receives data concerning the selected streams from the gateway 1231, formats it by encapsulating it in a burst 252 to broadcast it over a wireless local area network where the terminal 20 is which can so receive the burst 252 intended for it.

The control data 430 (per service) transmitted according to an IP broadcast protocol (SAP-SDP) by the gateway 123 to the terminal 20 is also illustrated in FIG. 4.

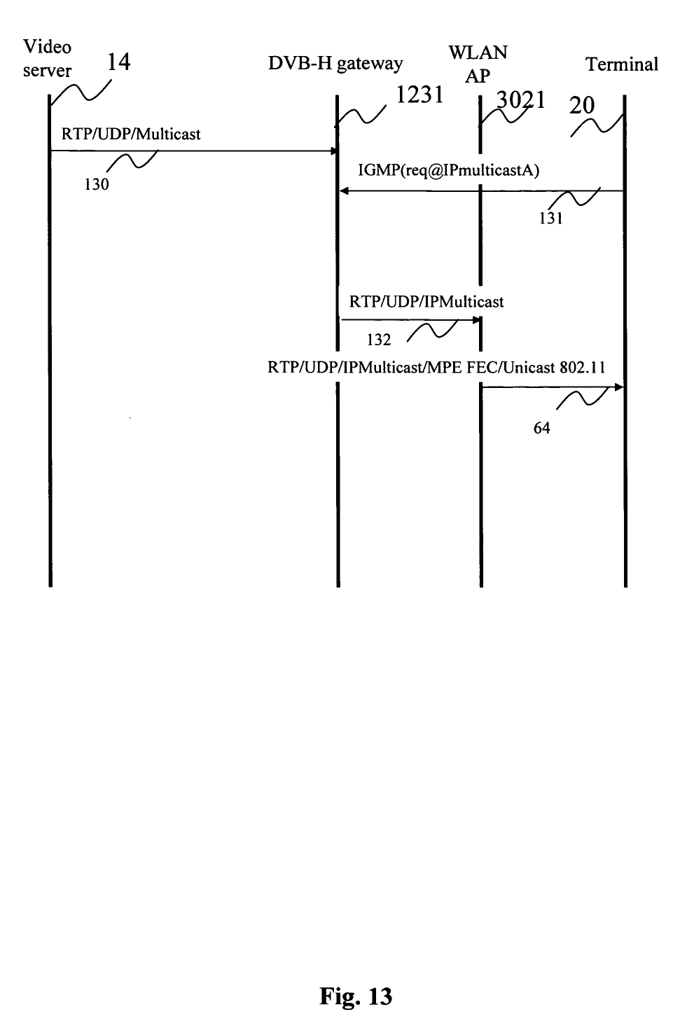

FIG. 13 presents the exchanges between the video coder 14, the gateway 1231, the access point 3021 and the terminal 20.

The video coder 14 transmits to the gateway 1231 via the DVB-H network 11 frames 130 (or 125 on FIG. 12) containing a video stream according to multicast protocol of the RTP/UDP type. This transmission is systematic or, preferentially, initiated when at least a gateway requires a digital audio/video service. When the terminal 20 cannot correctly receive the data via the DVB-H network 11 in a direct link, it transmits a request 131 to the gateway 1231. The request 131 is of the IGMP (or ‘Internet Group Management Protocol’) type and comprises the IP address of the desired video stream to select the corresponding service. The address of the desired video stream can be determined via a http point-to-point connection beforehand to the web portal 152 or thanks to a stream coming from the EPG server 151 (which corresponds to a stream with a known address of the terminal 20).

Following the reception of the request 131, the gateway 1231 duplicates the video stream contained in the frames corresponding to the IP address of the desired stream and encapsulates the video stream in a frame 132 of the IP broadcast type (IP multicast frame of the RTP/UDP type) that it transmits to the WLAN access point 3021. So, during this operation, the gateway 1231 also carries out a filtering since it only extracts from the received IP stream the streams requested by the IGMP request 131.

Then, the access point 3021 carries out transmission operations in a manner similar to the access point 2121 and in particular an encapsulation in a wireless frame 64 such as illustrated in respect of FIG. 5. Moreover, the access point 3021 has a structure similar to that of the access point 2121 illustrated in respect of FIG. 8.

Naturally, the invention is not limited to the embodiments previously described.

In particular, the embodiment described in respect of FIG. 3 also applies, according to a variant of the invention, to a domestic network (use of the WPE interface and of a standard wireless access point ).

Moreover, the invention applies to any type of reception of digital video streams transmitted in particular by ADSL, DVB (in particular DVB-T, DVB-H, DVB-S) encapsulated in frames with data representative of time slicing, these frames being transmitted over a wireless local area network to a digital audio/video terminal.

1. Gateway comprising:
a receiver of first frames of a digital video broadcasting service,
a module determining data representative of time slicing,
an encapsulator encapsulating each of the first service frames in a second frame comprising said data representative of a time-slice, and
a transmitter transmitting over a wireless local area network each second frame to a digital audio/video terminal.

2. Gateway according to claim 1, wherein said gateway comprises an inserter inserting data representative of a time-slice in each second frame according to a session description protocol.

3. Gateway according to claim 2, wherein said session description protocol is of the SAP-SDP type.

4. Gateway according to claim 1, wherein the receiver of first frames of a digital video broadcasting service is associated with a wired network.

5. Gateway according to claim 1, wherein the means for receiving the first frames of a digital video broadcasting service are associated with a wireless network.

6. Gateway according to claim 1, wherein said wireless network is of the IEEE 802.11, Hiperlan, IEEE802.15 or IEEE802.16 type.

7. Gateway according to claim 1, wherein said gateway comprises a detector detecting a power saving mode of a terminal receiving said second frames so as to transmit each second frame when the destination terminal is in the listening mode.

8. Gateway according to claim 1, wherein said service is of the DVB-H type.

9. Gateway according to claim 1, wherein each second frame comprises a destination address corresponding to a single terminal.

10. Gateway according to claim 1, wherein each second frame comprises a destination address corresponding to several terminals.

11. Gateway according to claim 1, wherein it comprises a module determining audio/video terminals and a filter filtering the first service frames received, only the service frames intended for one of said determined terminals being encapsulated by said encapsulation means.

12. Gateway according to claim 1, wherein the receiver of first frames of a digital video broadcasting service are associated with a long-distance wireless broadcasting network.

13. Digital audio/video terminal, wherein it comprises:
a receiver of second frames comprising data representative of a time-slice, the second frames being transmitted over a wireless local area network, and
an extractor extracting first service frames from said second frames.

14. Method for broadcasting digital video services comprising a step for receiving the first frames of a digital video broadcasting service, wherein said method comprises:
a step for determining data representative of a time-slice,
a step for encapsulating each of the first service frames in a second frame comprising said data representative of a time-slice, and
a step for transmitting over a wireless local area network each second frame to a digital audio/video terminal.

15. Method for receiving digital audio/video, wherein said method comprises:
a step for receiving second frames comprising data representative of a time-slice, the second frames being transmitted over a wireless local area network, and
a step for extracting first service frames from said second frames.
